(19) United States
(12) Patent Application Publication
(10) Pub. No.: US 2011/0126508 A1
(43) Pub. Date: Jun. 2, 2011

(54) FAN CASE HAVING PENETRATION RESISTANT BLANKET

(76) Inventor: EDWARD CLAUDE RICE, Indianapolis, IN (US)

(21) Appl. No.: 12/628,727

(22) Filed: Dec. 1, 2009

(51) Int. Cl. F02C 7/00; F04D 29/52

(52) U.S. Cl. 60/39.091; 415/182.1; 415/1

(57) ABSTRACT

A fan is disclosed herein. The fan includes a shaft rotatable about an axis. The fan also includes a blade engaged with the shaft for rotation about the axis. The fan also includes a case encircling the axis. The case is positioned radially outward of the blade and the shaft. The fan also includes a blanket mounted to the case. The case and the blanket are operable to cooperate with one another to prevent the blade from escaping the case upon the blade separating from the shaft. The blanket is at least partially impregnated with shear thickening fluid.

### BACKGROUND OF THE INVENTION

1. Field of the Invention

The invention relates to turbine engines.

2. Description of Related Prior Art

U.S. Pat. No. 6,612,217 discloses penetration resistant fabric structures and materials. A ballistic barrier is applied for protecting an aircraft from damage due to projectile penetration. The aircraft has a fuselage including an outer skin, an inner panel and a structure. The ballistic barrier disclosed in the '217 patent includes at least one layer of high strength fabric disposed between the outer skin and the inner panel of the aircraft. The fabric is substantially fixedly positioned with respect to the fuselage of the aircraft.

### SUMMARY OF THE INVENTION

In summary, the invention is a fan. The fan includes a shaft rotatable about an axis. The fan also includes a blade engaged with the shaft for rotation about the axis. The fan also includes a case encircling the axis. The case is positioned radially outward of the blade and the shaft. The fan also includes a blanket mounted to the case. The case and the blanket are operable to cooperate with one another to prevent the blade from escaping the case upon the blade separating from the shaft. The blanket is at least partially impregnated with shear thickening fluid.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a schematic view of a turbine engine which incorporates exemplary embodiments of the invention;

FIG. 2 is a cross-section of a blanket according to an exemplary embodiment of the invention;

FIG. 3 is a front view of a fan according to an exemplary embodiment of the invention; and

FIG. 4 is an enlarged portion of FIG. 1.

### DETAILED DESCRIPTION OF AN EXEMPLARY EMBODIMENT

A plurality of different embodiments of the invention is shown in the Figures of the application. Similar features are shown in the various embodiments of the invention. Similar features have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The invention, as exemplified in the embodiment described below, can be applied to contain components liberated from a turbine engine. The '217 patent described above is concerned with protecting the interior of a fuselage of an aircraft. As a result, the '217 patent requires extensive amounts of fabric. The fabric is applied to the fuselage and it is not possible to always predict the trajectory of components liberated from a turbine engine. Excessive fabric is therefore required for the invention disclosed in the '217 patent to protect the interior of the fuselage from all possible trajectories. The present invention, on the other hand, recognizes that applying penetration resistant fabric around the rotating components requires less fabric.

Another shortcoming of the '217 patent is that it fails to contemplate the risk of components liberated from a turbine engine relative to personnel not in the fuselage of an aircraft. In aircraft applications for turbine engines, components may become liberated from a turbine engine while the aircraft is on the ground. Such components pose a danger to ground crew, mechanics, and passengers boarding the aircraft. Further, turbine engines are also applied in non-aircraft applications. Such turbine engines can be operated in working environments for humans. Thus, the present invention provides two substantial improvements over the prior art, including minimizing the use of penetration-resistant fabric and providing a greater scope of protection.

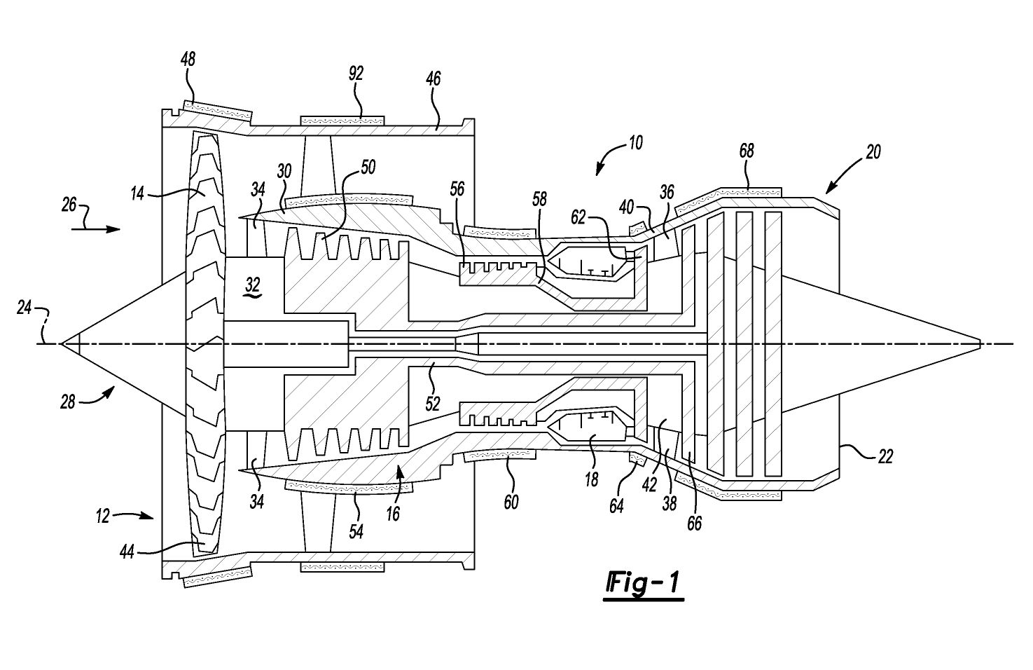

Referring to FIG. 1, a turbine engine 10 can include an inlet 12 and a fan 14. The exemplary fan 14 can be a bladed disk assembly having a disk or hub defining a plurality of slots and a plurality of fan blades, each fan blade received in one of the slots. In alternative embodiments of the invention, the fan can be a blisk wherein the hub and blades are integrally formed and unitary. The turbine engine can also include a compressor section 16, a combustor section 18, and a turbine section 20. The turbine engine 10 can also include an exhaust section 22. The fan 14, compressor section 16, and turbine section 20 include components arranged to rotate about a centerline axis 24. Fluid such as air can be drawn into the turbine engine 10 as indicated by the arrow referenced at 26. The fan 14 directs fluid to the compressor section 16 where it is compressed. A portion of the fluid can be diverted radially outside of the compressor section 16 and thereby become bypass flow. The compressed fluid emerging from the compressor section 16 is mixed with fuel and ignited in the combustor section 18. Combustion gases exit the combustor section 18 and flow through the turbine section 20. Energy is extracted from the combustion gases in the turbine section 20.

A nose cone assembly 28 can be attached to the fan 14. A turbine case 30 can encircle the core engine components (the compressor, combustor and turbine sections 16, 18, 20). The turbine case 30 can be fixed to a non-rotating hub 32 through a plurality of struts 34. Downstream of the combustor section 18, a row of turbine vanes, such as vanes 36, 38 can be positioned to direct the flow of combustion gases to the turbine section 20. The vanes 36, 38 can extend radially relative to the centerline axis 24, between an outer case 40 and an inner case 42. The outer case 40 can be integral with or separately formed from the case 30.

FIG. 1 shows several possible embodiments of the invention. The fan 14 can include a plurality of blades, such as the blade referenced at 44. The blade 44 is engaged with the shaft defined by the hub 32 for rotation about the axis 24. A case 46 encircles the axis 24. The case 46 is positioned radially outward of the blade 44 and the hub 32. A blanket 48 is mounted to the case 46. The case 46 and the blanket 48 are operable to cooperate with one another to prevent the blade 44 from escaping the case 46 upon the blade 44 separating from the hub 32. The blanket 48 is at least partially impregnated with shear thickening fluid.

In a second embodiment, a fan can be defined by the compressor section 16. A low-pressure (LP) compressor blade 50 can be engaged with an LP shaft 52 for rotation about the axis 24. The case 40 encircles the axis 24 and is positioned radially outward of the blade 50 and the LP shaft 52. A blanket 54 is mounted to the case 40. The case 40 and the blanket 54 are operable to cooperate with one another to prevent the blade 50 from escaping the case 40 upon the blade 50 separating from the shaft 52. The blanket 54 is at least partially impregnated with shear thickening fluid.

The exemplary compressor section 16 can also define a third embodiment. A high-pressure (HP) compressor blade 56 can be engaged with an HP shaft 58 for rotation about the axis 24. The case 40 is positioned radially outward of the blade 56 and the HP shaft 58. A blanket 60 is mounted to the case 40. The case 40 and the blanket 60 are operable to cooperate with one another to prevent the blade 56 from escaping the case 40 upon the blade 56 separating from the shaft 58. The blanket 60 is at least partially impregnated with shear thickening fluid.

The exemplary turbine section 20 can define a fourth embodiment. A high-pressure (HP) turbine blade 62 can be engaged with the HP shaft 58 for rotation about the axis 24. The case 40 is positioned radially outward of the blade 62. A blanket 64 is mounted to the case 40. The case 40 and the blanket 64 are operable to cooperate with one another to prevent the blade 62 from escaping the case 40 upon the blade 62 separating from the shaft 58. The blanket 64 is at least partially impregnated with shear thickening fluid.

The exemplary turbine section 20 can also define a fifth embodiment. A low-pressure (LP) turbine blade 66 can be engaged with the LP shaft 52 for rotation about the axis 24. The case 40 is positioned radially outward of the blade 66. A blanket 68 is mounted to the case 40. The case 40 and the blanket 68 are operable to cooperate with one another to prevent the blade 66 from escaping the case 40 upon the blade 66 separating from the shaft 52. The blanket 68 is at least partially impregnated with shear thickening fluid.

All of the exemplary blades 44, 50, 56, 62, 66 are operable to direct a working fluid along the centerline axis 24 and are fan-like in operation. All of the embodiments described above can be practiced together. Alternatively, less than all of the embodiments described above can be practiced together. Further, embodiments of the invention can be practiced in operating environments other than turbine engines.

The exemplary blankets 48, 54, 60, 64, 68 are at least partially impregnated with shear thickening fluids. Shear thickening fluids are composed of relatively hard particles suspended in a liquid. The liquid can be polyethylene glycol, which is non-toxic and can withstand a wide range of temperatures. The particles can be nano-particles of silica. The combination of the liquid and the particles is flowable. Shear thickening fluid can be obtained from University of Delaware, Office of Vice Provost for Research, Newark, Del. 19716-6408 (http://www.ccm.udel.edu/STF/index.html). In addition, U.S. Pat. Nos. 7,226,878 and 7,498,276 are hereby incorporated by reference for their teachings of impregnating textiles with shear thickening fluids.

One or more of the blankets 48, 54, 60, 64, 68 can be at least partially formed from para-aramid synthetic fibers. Aramid fibers are a class of heat-resistant and strong synthetic fibers. The name is a shortened form of “aromatic polyamide.” The fibers having the chain molecules highly oriented along the fiber axis, so the strength of the chemical bond can be exploited. The Federal Trade Commission definition for aramid fiber is a manufactured fiber in which the fiber-forming substance is a long-chain synthetic polyamide in which at least 85% of the amide linkages, (—CO—NH—) are attached directly to two aromatic rings. Aramids are aromatic polyamides. The prefix “para” refers to the position of the carboxylic and amine groups on the monomer ring. Examples of para-aramid synthetic fibers include Kevlar® and Twaron®. Other kinds of fibers can be applied in other embodiments of the invention.

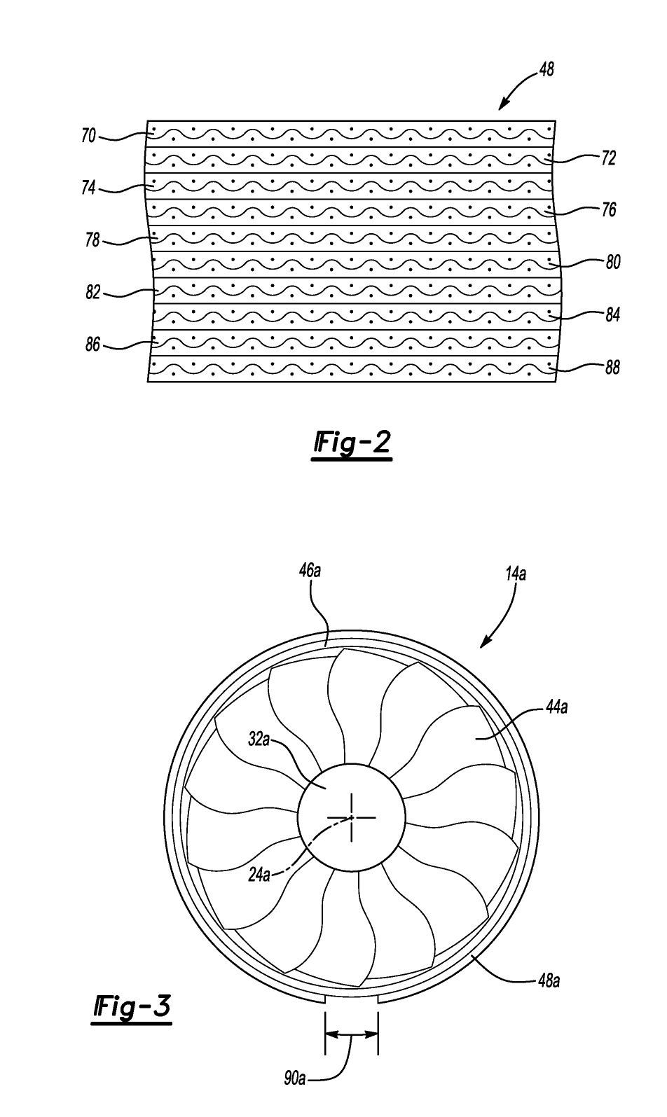

One or more of the blankets 48, 54, 60, 64, 68 can be formed from multiple layers of fabric stacked radially relative to the axis. The number of layers can be selected based on the possible impact load to be absorbed by the particular blanket. One or more of the blankets 48, 54, 60, 64, 68 can be formed from less or more than twenty-five layers. FIG. 2 shows a cross-section through the blanket 48. The exemplary blanket 48 is formed from fabric layers 70, 72, 74, 76, 78, 80, 82, 84, 86, 88. The layer 88 can be adjacent to the case 46 shown in FIG. 1 and the layer 70 can be positioned furthest from the case 46. The fabric layers 70-88 can be formed from the same materials or different materials. The fabric layers 70-88 can have the same thicknesses or different thicknesses. All or less than all of the fabric layers 70-88 can be impregnated with the shear thickening fluid. A blanket at least partially impregnated with shear thickening fluid can be smaller and weigh less than a blanket without shear thickening fluid. For example, one or more of the blankets 48, 54, 60, 64, 68 can weigh less than thirty-five pounds.

Referring again to FIG. 1, the exemplary blankets 48, 54, 60, 64, 68 are positioned on radially outward sides of the respective cases 46 and 40. In alternative embodiments of the invention, a blanket at least partially impregnated with shear thickening fluid could be positioned on a radially inward side of the case. Also, blankets could be positioned on both sides of the case in alternative embodiments.

The exemplary blankets 48, 54, 60, 64, 68 can fully encircle the respective cases 46 and 40. FIG. 3 shows an alternative embodiment in which a blanket 48a is mounted to a case 46a positioned radially outward of a blade 44a and a shaft 32a. The shaft 32a and blade 44a can rotate about an axis 24a. The blanket 48a extends less than 360° around the axis 24a. A gap 90a is defined at bottom dead center of the fan 14a. The cost of the blanket 48a can be reduced by allowing a bottom portion to be left uncovered.

The use of shear thickening fluids can be minimized if desired to reduce the cost of the blankets. Generally, the impregnated portion of the one or more of the blankets 48, 54, 60, 64, 68 can be positioned at position(s) that projectiles having the highest energy are likely to pass. A first approach to minimizing the use of shear thickening fluid can be to limit a width of a fully-impregnated blanket. For example, the width of the blanket 64 is substantially minimized along the axis 24 to substantially the distance that the blade 62 extends along the axis 24. A second approach can be to apply blankets with shear thickening fluid in combination with blankets without shear thickening fluid. For example, the blanket 48 can be at least partially impregnated with shear thickening fluid and can be positioned radially aligned with the blade 44 relative to the axis 24. A second blanket 92 can be mounted to the case 46, spaced along the axis 24 from the blade 44. The second blanket 92 can be positioned along a trajectory that the blade 44, if liberated from the hub 32, might pass. However, if the blade 44 passes toward the blanket 92 the energy of the blade 44 might be less than if the blade 44 passes toward the blanket 48.

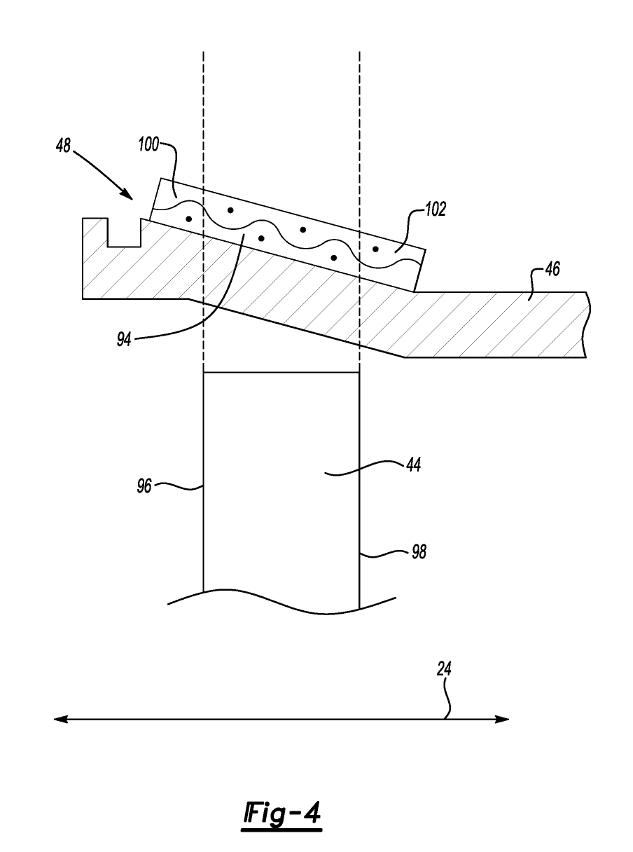

A third approach can be to apply blankets only partially impregnated with shear thickening fluid. FIG. 4 shows a close-up view of the blanket 48. The blanket 48 can include a portion 94. The portion 94 is defined along the axis 24 between the forward and aft edges 96, 98 of the blade 44. The blanket 48 can also include a portion 100 forward of the portion 94 and a portion 102 aft of the portion 94. The portion 94 impregnated with the shear thickening fluid can thus be radially aligned with the blade 44 relative to the axis 24. The portions 100 and 102 not having shear thickening fluid can be spaced from the blade 44 relative to the axis 24.

A fourth approach to minimizing the use of shear thickening fluid can be to apply multiple blankets radially spaced from one another. Referring again to FIG. 1, the blanket 54 can be at least partially impregnated with shear thickening fluid and the blanket 92 can be without shear thickening fluid. However, in alternative embodiments, a radially-outer blanket could be at least partially impregnated with shear thickening fluid and a radially-inner blanket can be without shear thickening fluid. The blanket with shear thickening fluid can have less shear thickening fluid because a liberated blade reaching the radially-outer blanket would have less energy after having passed through the radially-inner blanket.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. The right to claim elements and/or sub-combinations of the combinations disclosed herein is hereby reserved.

What is claimed is:

1. A fan comprising:
a shaft rotatable about an axis;
a blade engaged with said shaft for rotation about said axis;
a case encircling said axis and positioned radially outward of said blade and said shaft; and
a blanket mounted to said case wherein said case and said blanket are operable to cooperate with one another to prevent said blade from escaping said case upon said blade separating from said shaft, wherein said blanket is at least partially impregnated with shear thickening fluid.

2. The fan of claim 1 wherein said blanket is at least partially formed from para-aramid synthetic fibers.

3. The fan of claim 1 wherein said blanket is positioned on a radially outward side of said case.

4. The fan of claim 1 wherein said blanket is formed from multiple layers of fabric stacked radially relative to said axis.

5. The fan of claim 4 wherein less than all of said layers of fabric are impregnated with said shear thickening fluid.

6. The fan of claim 4 wherein said blanket is formed from less than twenty-five layers.

7. The fan of claim 4 wherein said blanket weighs less than thirty-five pounds.

8. A method for containing a blade rotatable about an axis comprising the steps of:
engaging the blade to a shaft rotatable about an axis;
encircling the blade and the shaft with a case; and
mounting a blanket at least partially impregnated with shear thickening fluid to the rigid case wherein the case and the blanket are operable to cooperate to prevent the blade from escaping the case upon the blade separating from the shaft.

9. The method of claim 8 wherein said mounting step is further defined as at least partially encircling the case with the blanket.

10. The method of claim 8 wherein said mounting step is further defined as limiting a width of the blanket along the axis to substantially the distance that the blade extends along the axis.

11. The method of claim 8 further comprising the step of:
positioning a second blanket without shear thickening fluid along the axis spaced from the blade.

12. The method of claim 8 wherein said mounting step is further defined as positioning a portion of the blanket impregnated with the shear thickening fluid to be radially aligned with the blade relative to the axis.

13. The method of claim 8 wherein said mounting step is further defined as positioning a portion of the blanket impregnated with the shear thickening fluid to extend less than 360° around the axis.

14. A turbine engine comprising:
at least one shaft rotatable about a centerline axis;
at least one blade engaged with said at least one shaft for rotation about said centerline axis to direct a working fluid along said centerline axis;
at least one case encircling said centerline axis and positioned radially outward of said at least one blade and said at least one shaft; and
at least one blanket mounted to said at least one case wherein said at least one case and said at least one blanket are operable to cooperate with one another to prevent said at least one blade from escaping said at least one case upon said at least one blade separating from said at least one shaft, wherein said at least one blanket is at least partially impregnated with shear thickening fluid.

15. The turbine engine of claim 14 wherein said at least one blade is further defined as a fan blade positioned adjacent to an intake of said turbine engine.

16. The turbine engine of claim 14 further comprising:
a compressor section, wherein said at least one blade is part of said compressor section.

17. The turbine engine of claim 14 further comprising:
a turbine section, wherein said at least one blade is part of said turbine section.

18. The turbine engine of claim 14 wherein:
said turbine engine further comprises an intake fan, a compressor section, and a turbine section;
said at least one blade includes a first blade being part of said intake fan, a second blade being part of said compressor section, and a third blade being part of said turbine section; and
said at least one blanket includes a first blanket at least partially encircling said intake fan, a second blanket at least partially encircling said compressor section, and a third blanket at least partially encircling said turbine section.

19. The turbine engine of claim 14 further comprising:
a second blanket spaced radially from and aligned along said centerline axis with said at least one blanket, wherein said second blanket is free of shear thickening fluid.

20. The turbine engine of claim 19 wherein said second blanket is further defined as being spaced radially outward from said at least one blanket.
